(19) United States
(12) Patent Application Publication
(10) Pub. No.: US 2005/0026626 A1
(43) Pub. Date: Feb. 3, 2005

(54) Wireless network with positioned mobile devices

(75) Inventors: Klaus G. Carl, Boca Raton, FL (US); Roland Klingert, Boca Raton, FL (US)

Correspondence Address: Elsa Keller;Siemens Corporation, Intellectual Property Department, 170 Wood Avenue South, Iselin, NJ, 08830, US

(73) Assignee: Siemens Information and Communication Mobile, LLC.

(21) Appl. No.: 10/632,334

(22) Filed: Aug. 1, 2003

(51) Int. Cl. H04Q 7/20

(52) U.S. Cl. 455/456.1; 455/466; 455/524

(57) ABSTRACT

A wireless communications network such as a Global System for Mobile Communication (GSM) network. At least one Mobile Subscriber (MS) unit includes a position location receiver, which may be a Global Positioning System (GPS) receiver. The MS unit selectively provides a current location with current signal reception measurements to a local base transceiver station (BTS) for use in the network.

### BACKGROUND OF THE INVENTION

1. Field of the Invention

The present invention is related to a wireless communications network and more particularly to a wireless communications network with globally positioned mobile station units.

2. Background Description

Wireless communication systems, such as those supporting Global System for Mobile Communication (GSM), Time Division Multiple Access (TDMA) and Code Division Multiple Access (CDMA) technologies, employ a base transceiver station (BTS) in each cell or cell sector. Each base station supports wireless communication with mobile subscriber (MS) units in that cell. Typical MS communications units are, for example, cellular telephone (cell phone) handsets, PDAs, laptops and other devices with a wireless communications interface.

For good communications, each MS unit must have an adequate signal and each base station must have very precise and stable transmission timing. Timing and signal quality is measured for each individual MS unit in real time and adjusted as needed. Typically, during power on registration when the MS unit (e.g., a cell phone) turns on, the MS unit measures the reception levels, timing skew and reception quality with all surrounding transmitter frequencies. Then, the MS unit relays the measurements with what is typically referred to as class mark information (user equipment capability information) to the BTS for evaluation in the network (e.g., by the BTS) to determine the best signal reception quality. Normally, the MS unit is assigned to the frequency with the strongest signal. Thereafter, the MS unit may continuously repeat the reception level, skew and quality measurements and report measurement results to the BTS.

In addition to wireless verbal and data communications, state of the art land based wireless communications technologies (e.g., GSM) have found application for low cost location and positioning, e.g., using enhanced Cell IDentifier/Timing Advance (eCI-TA) measurements. Essentially, network planning tools determine timing advance and power measurements within a particular cell and the measurements are stored in a database, an eCI-TA database. A positioning algorithm locates user positions within the cell from predicted database values. Using eCI-TA data, a MS unit can be located to within 100 meters (100 m) in dense urban areas. Typical Global Positioning System (GPS) measurements are accurate to within 10 m, but are seldom available in enclosed areas, e.g., buildings. Since state of the art wireless communications technologies can penetrate buildings, they have been combined with GPS to extend the reach of positioning devices and have improved positional accuracy. Thus, application of cellular technology (eCI-TA) to GPS has extended the positioning capability of GPS receivers and for improved positional accuracy, such as is described for example in www.benefon.com/solutions_partners/partner_area/mobile_positioning_technology.

### SUMMARY OF THE INVENTION

It is a purpose of the invention to improve mobile station signal reception measurement collection;

It is another purpose of the invention to facilitate collection of mobile station signal reception measurements;

It is yet another purpose of the invention to maintain data integrity in mobile station signal reception prediction databases;

It is yet another purpose of the invention to improve information dissemination to cellular network mobile subscribers.

The present invention relates to a wireless communications network such as a Global System for Mobile Communication (GSM) network. At least one Mobile Subscriber (MS) unit includes a position location receiver, which may be a Global Positioning System (GPS) receiver. The MS unit selectively provides a current location with current signal reception measurements to a local base transceiver station (BTS) for use in the network.

### BRIEF DESCRIPTION OF THE DRAWINGS

The foregoing and other objects; aspects and advantages will be better understood from the following detailed description of a preferred embodiment of the invention with reference to the drawings, in which:

FIG. 1 shows an example of a wireless data communications system or network according to a preferred embodiment of the present invention;

FIG. 2 shows an example of how signal reception measurements may be collected and provided with the measurement location to a local BTS.

### DESCRIPTION OF PREFERRED EMBODIMENTS

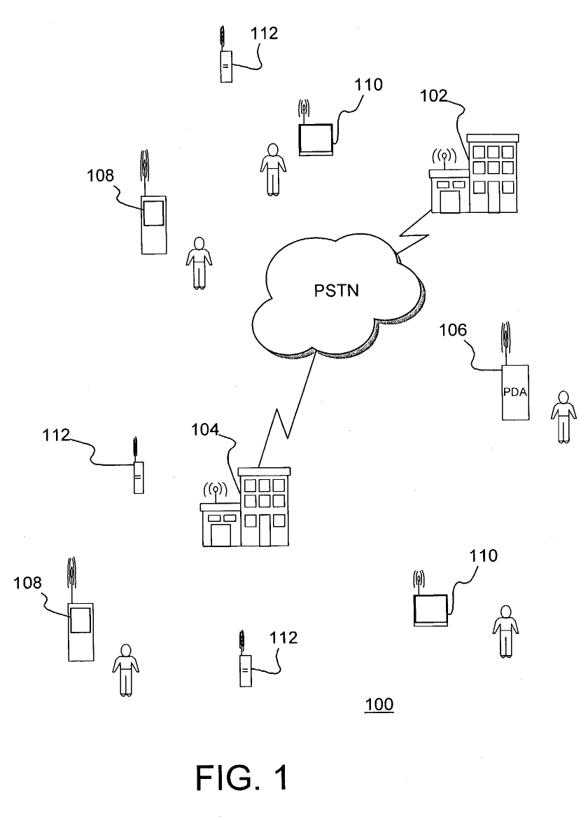

Turning now to the drawings and, more particularly, FIG. 1 shows an example of a wireless communications system or wireless network 100 (e.g., Global System for Mobile Communication (GSM)) according to a preferred embodiment of the present invention. A preferred wireless network or Public Land Mobile Network (PLMN) 100 includes one or more-cells, each serviced by a local base transceiver station (BTS) 102, 104. Mobile Subscriber (MS) units or wireless communications devices 106, 108, 110, 112 in the cell communicate wirelessly through the local base station 102, 104. At least one of the wireless devices 106, 108, 110, 112 includes a Global Positioning System (GPS) receiver, hereinafter a GP-MS unit. Mobile network positioning in combination with GPS positioning serves to provide any particular GP-MS user that is within the network reception area with positional accuracy to within 1 m. In addition, however, each active GP-MS seamlessly passes positional information (e.g., the same positional information provided to the user) to the BTS 102, 104 without requiring awareness, much less manual intervention from the GP-MS unit user. Coincidentally and automatically or at the behest of the BTS 102, 104, each GP-MS unit may provide located reception measurements, i.e., reception measurements accompanied by the specific location at which each of the measurements were made.

The current GSM specification defines a number of ways in two categories to determine the position of a particular MS 106, 108, 110, 112. The MS 106, 108, 110, 112 may calculate its position with optional assistance data or, the position calculation measurements may be transferred to a central entity, which calculates the position of the particular MS 106, 108, 110, 112 in the network. Additionally, any MS 106, 108, 110, 112 in dedicated mode (e.g., ongoing call) typically sends network measurement reports containing measured reception power levels twice a second (every 480 ms). Thus, each time the MS 106, 108, 110, 112 sends its position or the network calculates its position, the position may be combined with a most recent network measurement report in the network 100.

Each MS 106, 108, 110, 112 may be any appropriate wireless communications device such as a second generation (2G) or third generation (3G) wireless communications or wireless data capable (e.g., SMS) device suitable for including a seamless GPS receiver. Examples of such wireless devices include a Personal Digital Assistant (PDA) 106 with wireless connectivity, a cellular phone 108, a wireless tablet/notebook computer 110 or a simple text messaging device 112. Each GP-MS unit, e.g., PDA 106, periodically provides the unit location, preferably, with normal unit reception signal measurements to its local BTS 102, 104. Thus, the network 100 is continuously receiving GP-MS unit positional information and optional signal characterization data, e.g., local signal quality measurements, at specific locations within the network 100, from each GP-MS unit in range of a BTS 102, 104. It is understood that, although described herein with application to GPS, this is for example only. The present invention has application to other positioning systems (e.g., Assisted GPS (A-GPS)) or other satellite-based systems such as, for example, GLONASS, the currently developed European Galileo system, or to positioning methods using time difference measurements of the radio signals, e.g., Enhanced Observed Time Difference (EOTD) or Uplink Time Difference of Arrival (UTDOA).

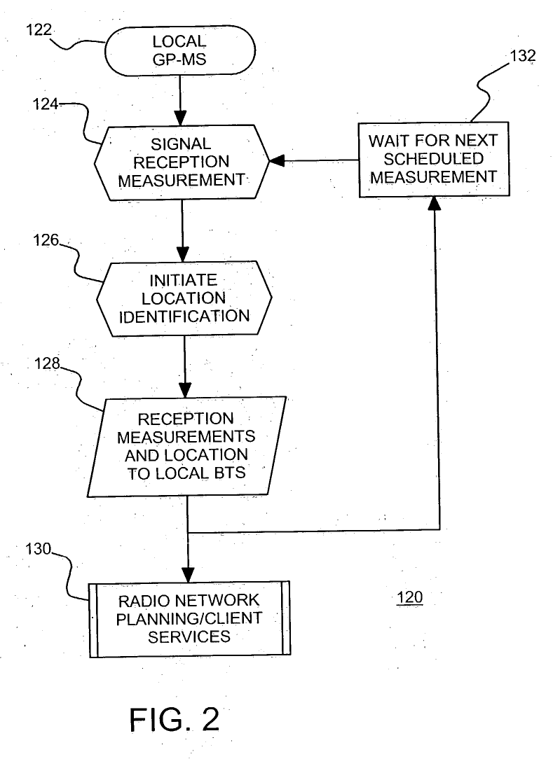

FIG. 2 shows in a flow diagram 120 an example of how signal reception measurements may be collected and provided with the measurement location to a local BTS 102, 104 according to a preferred embodiment of the present invention with reference to the network example 100 of FIG. 1. In step 122 a BTS (e.g., 102) becomes aware of the presence of a GP-MS unit (e.g., 106), e.g., at a power up, a handover between BTSs 102, 104 or, when the GP-MS 106 initially enters the network 100 coverage area. In step 124, the GP-MS unit 106 measures local reception, e.g., for comparison and update of previously collected enhanced Cell ID/Timing Advance (eCI-TA) measurement data. In step 126 the GP-MS unit 106 locates its global position. It should be noted that steps 124 and 126 may occur simultaneously or step 126 may occur before step 124. In step 128 the GP-MS unit 106 passes the global position with the local reception measurement data for use by radio network planning (RNP) tools or other client services 130. In step 132, if subsequent periodic measurements are selected for automatic measurement or whenever subsequent measurements are requested, at the next scheduled/requested measurement time, the GP-MS unit returns to take signal measurements in step 124 and the locate the GP-MS unit position in step 126. Also, optionally, only the position may be measured in subsequent measurements, skipping step 124 and proceeding directly to measurement step 126.

So for example, upon power up in step 122 the GP-MS unit 106 collects normal power up registration data in step 124 and also takes the unit GPS location in step 126, which is sent to the local BTS 102 in step 128. Preferably, the updated GPS location is included with each subsequent measurement that the GP-MS unit 106 provides to the local BTS 102. During a “hand over” procedure, when a unit 106, 108, 110, 112 moves from a first cell (e.g., with diminishing signal quality from BTS 102) to another (e.g., with improving signal quality from BTS 104), the GP-MS unit 106 performs a similar initial measurement. Further, the positional measurements may be made automatically or, the network can request an initial position calculation and, selectively, continue to request position calculations periodically. Once collected, the network can use the measurements periodically in step 130 for eCI-TA database updates for example or, when measured reception levels and quality vary beyond an accepted threshold from an expected reception level and quality. Such a variance may trigger off line applications, e.g., RNP tools.

Thus, the present invention has application to maintaining and updating a reception prediction database used for determining MS unit locations such as the Serving Mobile Location Center (SMLC) eCI-TA prediction database described in PCT patent application No. WO 02/239773, entitled “Method And Device For Traffic Localisation In A Cellular Mobile Radio Network” to Majewski, assigned to the assignee of the present invention. Majewski teaches a method of determining radio traffic density in an area using an algorithm and database similar to or identical with eCI-TA and the same eCI-TA database for traffic localization. Data for the database, whether the eCI-TA database or a separate database, is collected (manually collected offline or generated by RNP tools based on topological assumptions) from reception level measurements. Manual measurement collection entails, for example, initially selecting points within the network and measuring the signal reception level at each point. The RNP tools apply a mathematical model to measurements to predict signal strength. The model is based on reception level assumptions with respect to transmitter power levels and considering geographic situations like hills or valleys, buildings and roads within the network. Regardless of the source of the input data, the same manual measurement and prediction steps are repeated from time to time to keep the eCI-TA database current and in synch with environmental changes.

However, according to a preferred embodiment of the present invention each local GP-MS unit provides real time measurements to update prediction levels. Thus, measurement and calculation errors may be identified quickly, e.g., as soon as a GP-MS unit strays into a predicted area. Also, reception levels that may change with environmental condition changes are also measured and corrected in real time. Optionally, especially for a network with several local GP-MS units, the manual measurements may be replaced with measurements from the local GP-MS units. So, as illustrated in FIG. 2 upon detection of GP-MS units in an established network, the network requests the position and the reception levels from each of the GP-MS units, processes the measurements that the GP-MS units provide, generates a SMLC eCI-TA prediction database and, thereafter, updates the database. Advantageously, the time consuming, manpower intensive task of manually collecting measurements in the network area is no longer necessary. Further, the predicted measurements are continuously corrected, increasing the location calculation accuracy. Also, the corrections occur in real time, as changes occur in the network, with the most frequented areas of the network having the highest accuracy.

In addition, the network can be predisposed to provide information to GP-MS unit users any number of ways. The network can provide location specific information to GP-MS units as each is located at particular locations within the network reception areas. A preferred network can provide an emergency warning service that warns GP-MS unit users of local hazardous circumstances. Short message service SMS messages with warning information can be sent to specific GP-MS units in cars, e.g., approaching an accident on I-95 from the North can be warned, while South-bound GP-MS unit users are not bothered. A preferred network can provide an advertising service to inform specific GP-MS unit users about certain local commercial activities, e.g., as a GP-MS unit approaches a shopping area or shopping center, SMS messages can advertise 1 hour specials, indicate which stores are located in the area or provide store hours. More generally, a preferred network can provide an event information service to inform GP-MS unit users about upcoming local events. Thus, instead of being inundated with extraneous and often irrelevant broadcast information, e.g., an accident across town or a county fair in another state, users are provided with custom tailored, personally directed local information.

While the invention has been described in terms of preferred embodiments, those skilled in the art will recognize that the invention can be practiced with modification within the spirit and scope of the appended claims.

1. A wireless communications network comprising:
at least one network cell;
a base transceiver station (BTS) in each said network cell;
a plurality of Mobile Subscriber (MS) units, said MS units in each said network cell communicating wirelessly with said BTS; and
a position location receiver in at least one MS unit, said at least one MS unit being a positioned MS unit selectively providing located reception measurements to said BTS, located reception measurements including a current MS unit location with current signal reception measurements.

2. A wireless communications network as in claim 1, wherein said at least one cell is a plurality of cells, said at least one positioned MS unit is a plurality of positioned MS units providing current location signal reception measurements to a local said BTS at a selected time.

3. A wireless communications network as in claim 2, wherein said local BTS selects said selected time.

4. A wireless communications network as in claim 1, wherein said position location receiver is a Global Positioning System (GPS) receiver.

5. A wireless communications network as in claim 1, further comprising a reception level database predicting reception levels at locations within each said network cell, said network updating said reception level database responsive to said located reception measurements.

6. A wireless communications network as in claim 1, wherein said BTS provides location specific information to said positioned MS unit.

7. A wireless communications network as in claim 6, said location specific information indicating local commercial activities.

8. A wireless communications network as in claim 6, said location specific information indicates local hazards.

9. A wireless communications network as in claim 6, said location specific information being provided as short message service (SMS) messages.

10. A wireless communications network as in claim 1, said wireless communications network is a Global System for Mobile Communication (GSM) network.

11. A wireless communications network comprising:
a plurality of network cells distributed over a wireless communications network coverage area;
a base transceiver station (BTS) serving each of said plurality of network cells;
a plurality of Mobile Subscriber (MS) units in each of said plurality of network cells;
a positioned MS unit in ones of said plurality of network cells, said positioned MS unit including a position location receiver locating the global position of said positioned MS unit; and
each said positioned MS unit providing located reception measurements to a local said BTS, located reception measurements including a MS unit current location with current signal reception measurements.

12. A wireless communications network as in claim 11, further comprising a reception level database predicting reception levels at locations within said wireless communications network coverage area, said network updating said reception level database responsive to said located reception measurements.

13. A wireless communications network as in claim 11, wherein said plurality of MS units comprise a Personal Digital Assistant (PDA) with wireless connectivity, a cellular phone, a notebook computer, a tablet computer and a text messaging device.

14. A wireless communications network as in claim 11, wherein said local BTS in ones of said plurality of network cells selectively provide location specific information to selected positioned MS units.

15. A wireless communications network as in claim 14, wherein said location specific information indicates local commercial activities.

16. A wireless communications network as in claim 14, wherein said location specific information indicates local hazards.

17. A wireless communications network as in claim 14, wherein said location specific information being provided as short message service (SMS) messages.

18. A wireless communications network as in claim 11, wherein said wireless communications network is a Global System for Mobile Communication (GSM) network and at least one said positioned MS unit includes a Global Positioning System (GPS) receiver, said GPS receiver being said position location receiver.

19. A method of managing a wireless communications network, said method comprising the steps of:
a) measuring signal reception level at a Mobile Subscriber (MS) unit;
b) locating the position of said MS unit;
c) providing measured said reception level and said located position to a base transceiver station (BTS); and
d) returning to measuring step (a) at a selected time.

20. A method of managing a wireless communications network as in claim 19, wherein said selected time in step (d) is selected by said BTS.

21. A method of managing a wireless communications network as in claim 19, wherein said selected time in step (d) is automatically selected.

22. A method of managing a wireless communications network as in claim 19, wherein before step (d) said method further comprises the step of:
c1) updating predicted reception levels in a reception level database responsive to a located said position and said signal reception measurements from said MS unit.

23. A method of managing a wireless communications network as in claim 19, wherein before step (d) said method further comprises the step of:
c1) providing location specific information from said BTS to said MS unit.

24. A method of managing a wireless communications network as in claim 23, wherein said location specific information indicates commercial activities local to said MS unit.

25. A method of managing a wireless communications network as in claim 19, wherein said location specific information indicates local hazards.

26. A method of managing a wireless communications network as in claim 19, wherein said location specific information is provided as short message service (SMS) messages.
